(19) United States
(12) Patent Application Publication
(10) Pub. No.: US 2005/0062202 A1
(43) Pub. Date: Mar. 24, 2005

(54) Method of manufacturing a nozzle arrangement

(75) Inventor: Keith Laidler, Stourbridge, West Midlands (GB)

Correspondence Address: PILLSBURY WINTHROP, LLP, P.O. BOX 10500, MCLEAN, VA, 22102, US

(73) Assignee: Incro Limited, Stourbridge (GB)

(21) Appl. No.: 10/497,906

(22) PCT Filed: Dec. 6, 2002
(86) PCT No.: PCT/GB02/05529

(30) Foreign Application Priority Data
Dec. 8, 2001 (GB) 0129438.8
Aug. 12, 2002 (GB) 0218697.1

(51) Int. Cl. B29C 31/00

(52) U.S. Cl. 264/328.1; 264/572; 264/259

(57) ABSTRACT

A method of manufacturing a split nozzle arrangement includes injecting a mixture of a plastic base material and a foaming or blowing agent into a mold of the nozzle arrangement, allowing the plastic base material to set or harden and subsequently removing the final molded nozzle arrangement from the mold. The foaming or blowing agent produces bubbles or pockets of gas in the plastic base material and thus forms a final molded article in which at least 90% of the bubbles or pockets of gas have a maximum dimension of 0.5 millimeters or less. The plastic base material can be, for example, a thermoplastic material and the foaming or blowing agent can be, for example, a mixture of bicarbonate of soda and acetic acid.

### CROSS-REFERENCE TO RELATED APPLICATIONS

This application is the U.S. National Stage of International Application No. PCT/GB02/05529, filed Dec. 6, 2002, which relies upon and claims priority to Application Nos. GB. 0129438.8, filed Dec. 8, 2001, and GB 0218697.1, filed Aug. 12, 2002.

### BACKGROUND OF THE INVENTION

1. Field of the Invention

This invention relates to a method of manufacturing a nozzle arrangement. More particularly, this invention relates to a method of manufacturing a split nozzle arrangement as defined herein.

2. Description of Related Art

Nozzle arrangements are widely used to actuate and control the release of a whole range of commercially available products, illustrative examples of which include insecticides, paints and lacquers, air freshener, waxes and polishes, oven cleaners, starches and fabric cleaners, window/glass cleaners, shoe/leather cleaners, household products, hair care products, colognes and perfumes, deodorant or body sprays, antiperspirants, pharmaceuticals, industrial products and certain food products.

Nozzle arrangements are commonly fitted to pressurized containers, such as a portable aerosol canister. One of the most widely used forms of such nozzle arrangements is a so-called “spray-through cap” which is fitted to one end of an aerosol canister and comprises an actuator which is configured to selectively engage with and open an outlet valve of the aerosol canister, thereby enabling the release of the product stored in the container to be actuated by the operation of the actuator.

Nozzle arrangements are also present in so-called pump or trigger nozzle devices, which are fitted to the openings of various non-pressurized containers to provide a means by which the product stored therein can be dispensed through the nozzle arrangement. The product stored in such containers can be dispensed through the nozzle arrangement by the operation of the pump or trigger, which effectively pumps the product through the nozzle arrangement.

A typical nozzle arrangement has a body that is adapted to be fitted to a container in the vicinity of its outlet. The body also typically comprises an inlet that receives the product released or ejected from the container and directs it into a fluid flow passage which connects the inlet to an outlet through which the product flowing through the arrangement is ejected into the external environment, typically in the form of a spray.

More recently, split nozzle arrangements have been-developed. By “split nozzle arrangement,” it is meant a nozzle arrangement which is formed from at least two component parts, each of said parts having an abutment surface which, when brought into abutment with one another, define therebetween the outlet, a fluid flow passage and at least a portion of the inlet of the nozzle arrangement. Examples of such nozzle arrangements are described in WO 97/31841 and WO 01/89958, the entire contents of each of which are incorporated herein by reference.

Split nozzle arrangements are typically made of plastic and are manufactured by conventional plastic molding techniques. However, problems can arise when split nozzle arrangements are manufactured using an injection molding process because it is quite common for a phenomenon known as sinkage to occur. Sinkage occurs when a molded article cools following its removal from the mold and the cooling of the plastic results in the shrinkage of the plastic in certain areas and ultimately results in a distortion of the shape, or “sinkage,” occurring at certain surfaces of the article. This distortion in shape is of no real function importance in situations where the molded article is, for example, a plastic washing-up bowl. However, sinkage can be a problem in a split nozzle arrangement of two-part construction, such as those described in WO 97/31841 or WO 01/89958, because the occurrence of even a small amount of sinkage at one of the abutment surfaces can result in the distortion of the structure of the fluid flow passage, the inlet or the outlet. Such distortions in structure are a particular problem if they occur in the vicinity of a critical part of the nozzle arrangement such as, for example, the outlet orifice or any internal features that may be formed in the fluid flow passageway (e.g. one or more expansion chambers, inner orifices, venturi chambers, swirl chambers or multiple channels etc.), because the precision with which these features are formed is critical to enable the nozzle arrangement to function properly and produce a spray having the desired properties (i.e. spray droplet size distribution, the extent of dispersion, the volume of fluid dispensed, etc.).

In addition, distortion in the shape of the abutment surfaces or sealing elements provided on each of the two separable parts can frequently result in the leakage of fluid passing through the nozzle arrangement and the subsequent seepage of the leaked fluid between the abutment surfaces.

### BRIEF SUMMARY OF THE INVENTION

An aspect of the present invention is to provide a method of manufacturing a split nozzle arrangement of an aerosol in which the problem of shrinkage is obviated or at least minimized.

Therefore, in accordance with an embodiment of the present invention there is provided a method of manufacturing a split nozzle arrangement, the method including: injecting a mold for the nozzle arrangement with a mixture of a plastic base material and a foaming or blowing agent; allowing the plastic base material to set or harden; and removing the hardened plastic molded nozzle arrangement from the mold.

The foaming or blowing agent is capable of producing bubbles or pockets of gas in the plastic base material to form a hardened plastic molded nozzle arrangement in which at least 90% of the bubbles or pockets of gas have a maximum size dimension of 0.5 millimeters or less.

### DETAILED DESCRIPTION OF SEVERAL EMBODIMENTS OF THE INVENTION

Foaming or blowing agents are conventionally used in plastic injection molding processes to produce molded articles that are composed of both thick and thin sections of plastic. However, foaming or blowing agents have not been used in the preparation of a plastic molded article such as an aerosol nozzle arrangement which, in the areas where sinkage can be a particular problem (such as the fluid flow passage, the inlet or the outlet), is principally formed of think sections of molded plastic, generally having thicknesses within the range of 0.5 to 1.0 millimeters, with a thickness of 0.7 millimeters being most usual. This is primarily because a blowing agent would not be expected to alleviate the problem in such extremely thin sections of plastic where the amount of sinkage that occurs can be very small, for example of the order of 0.2 to 0.1 millimeters, and as such may not even be visible to the naked eye. Furthermore, it would not be expected that a plastic base material/foaming or blowing agent mixture could be provided which (i) contains sufficient foaming or blowing agent to address the problems of sinkage in these thin sections of plastic, and (ii) does not result in two common problems associated with the use of a foaming blowing agent, namely the occurrence of over expansion in areas of the mold (which can again adversely effect the structure and performance of the nozzle arrangement), and the occurrence of a problem known as “break-through” which arises when bubbles or pockets of gas generated by the foaming or blowing agent puncture a surface of the molded article, thereby adversely affecting the profile of that surface. It will of course be appreciated that if either of the aforementioned problems were to cause the distortion of one or more of the abutment surfaces of the component parts of the split nozzle, then the abutment surfaces would not fit together properly and this could result in the leakage of fluid passing through the inlet, outlet and/or fluid flow passage formed between the abutment surfaces.

Furthermore, the addition of a foaming or blowing agent would not be expected to solve the problem of sinkage reliably in a split nozzle arrangement, particularly given the tight tolerances that must be achieved, and for this reason, current attempts in this field to solve this problem have focused on alternative methods, such as methods of forcing more plastic base material into the mold or the use of filler materials (e.g. chalk or talcum powder).

Despite the anticipated problems connected with the use of a foaming or blowing agent, surprisingly the inventor has found that by using a selected class of foaming or blowing agents which are capable of producing “microbubbles,” i.e. bubbles or pockets of gas at least 90% of which have a diameter, or other maximum dimension, of up to 0.5 millimeters or less, it is possible to produce a plastic molded split nozzle arrangement in which the problem if sinkage is obviated.

Furthermore, the introduction of a foaming or blowing agent into the plastic base material improves the melt-flow characteristics of the plastic base materials when compared with the plastic base material alone, i.e. without the addition of the foaming or blowing agent. These improved flow properties enable the mold to be completely filled by the plastic base material/foaming or blowing agent mixture and this circumvents any further manufacturing problems associated with the incomplete filling of the mold.

In an embodiment, 95% of the bubbles or pockets of gas formed by the foaming or blowing agent have a maximum diameter or other dimension of 0.5 millimeters or less. Most preferably, 98-99% of the bubbles or pockets of gas formed by the foaming or blowing agent have a maximum diameter or other dimension of 0.5 millimeters or less.

In another embodiment, 98-99% of the microbubbles formed by the foaming or blowing agent have a maximum diameter, or other maximum dimension, of less than 0.15 millimeters and, most preferably, of less than 0.07 millimeters.

In yet another embodiment, the plastics base material from which the nozzle arrangement is to be manufactured is a thermoplastic material which is initially in a liquid or “flowable” form prior to injection into the mold and can then be allowed to set or harden by heating and subsequent cooling the mixture to yield the final molded nozzle arrangement.

The foaming or blowing agent may be an exothermic foaming or blowing agent, but is preferably an endothermic foaming or blowing agent. By “endothermic foaming or blowing agent,” it is meant a foaming or blowing agent that, under the conditions employed in the molding process, absorbs heat from the surroundings to initiate either the chemical reaction or decomposition of the foaming or blowing agents to give off a gas. The gas is preferably carbon dioxide. Endothermic foaming or blowing agents are especially useful if the plastic base material is thermoplastic material. The gas produced by the endothermic foaming or blowing agents introduces a microcellular foam structure to the plastic base material in the mold. It is this microcellular foam structure which is believe to prevent the occurrence of shrinkage in the final nozzle arrangement.

In an embodiment, the foaming or blowing agent that is mixed with the plastic base material prior to injection into the mold is a foaming or blowing agent which comprises a mixture of bicarbonate of soda and acetic acid. The bicarbonate of soda undergoes a reaction with the acetic acid to generate microbubbles of carbon dioxide that have a maximum diameter, or other dimension, that is less than 0.2 millimeters. These microbubbles are dispersed within the plastic base material present in the mold and the presence of the bubbles within the final molded split nozzle arrangement prevents sinkage occurring in the nozzle arrangement. Examples of such blowing agents include the blowing agents sold under the trade mark SAFOAM FPE 50 by Reedy International and the blowing agents sold under the trade mark MAXITHEN (such as the MAXITHEN HP789450 TR and HP78/700 TR blowing agents) by Gabriel-Chemie UK Limited.

In an embodiment, the bicarbonate of soda/acetic acid mixture is present in the plastic base material at a concentration within the range of 0.3% to 3% w/v.

The type and concentration of the blowing agent present in the mixture, together with the conditions in the mold, are such that bubbles or pockets of gas generated by the foaming or blowing agent do not result in the problem of break-through (i.e. the bubbles do not puncture the surface of the molded article) because, as previously mentioned, the resultant imperfections in the walls and surfaces molded nozzle arrangement could give rise to leakage.

In an embodiment, the blowing agent is provided, and mixed with the plastic base material, in a powder form.

The blowing agent may in practice be mixed into the plastic base material prior to injection of the mixture into the mold or, alternatively, may be mixed at the point of injection or by simultaneous injection into the mold.

The at least two separable parts of the nozzle arrangements formed by the method of the present invention can be separated during use to allow access to the fluid flow channel in the nozzle arrangement which is useful to enable the cleaning of the nozzle arrangement and thereby prevent the nozzle arrangement from becoming blocked. Alternatively, the at least two parts can be ultrasonically welded together following manufacture.

The invention will now be described further in reference to the following specific Example.

### EXAMPLE

### Preparation of a Spray-Through Cap Nozzle Arrangement for use with an Aerosol Canister

A spray-through cap nozzle arrangement was prepared by injecting a mixture of polypropylene and 2% w/v SAFOAM® FPE 50 into a mold. The mixture was then heated for 10 seconds at an elevated temperature in the mold and then allowed to cool. A spray-through cap nozzle arrangement is formed in which no sinkage is evident.

In contrast, the equivalent article prepared without the SAFOAM® FPE 50 blowing agent, results in a spray-through cap nozzle arrangement in which sinkage is evident.

It is of course understood that the invention is not intended to be restricted to the details of the above embodiment which is described by way of example only.

Furthermore, since numerous modifications and changes will readily occur to those of skill in the art, it is not desired to limit the invention to the exact construction and operation described therein. Accordingly, all suitable modifications and equivalents should be considered as falling within the spirit and scope of the invention.

1. A method of manufacturing a split nozzle arrangement, of comprising:
injecting a mold for said nozzle arrangement with a mixture of a plastic base material and a foaming or blowing agent;
allowing said plastic base material to set or harden; and
removing the hardened plastic molded nozzle arrangement from the mold,
wherein said foaming or blowing agent is capable of producing bubbles or pockets of gas in the plastic base material to form a hardened plastic molded nozzle arrangement in which at least 90% of said bubbles or pockets of gas have a maximum size dimension of 0.5 millimeters or less.

2. The method as claimed in claim 1, wherein said plastic base material is a thermoplastic.

3. The method as claimed in claim 1, wherein said foaming or blowing agent is an endothermic foaming or blowing agent.

4. The method as claimed in claim 3, wherein said foaming or blowing agent comprises a mixture of bicarbonate of soda and acetic acid.

5. The method as claimed in claim 4, wherein said mixture of bicarbonate of soda and acetic acid is present in the plastic base material at a concentration of 0.3% to 3% w/v.

6. The method as claimed in claim 4, wherein said mixture of bicarbonate of soda and acetic acid is provided in powder form for mixing with said plastic base material.

7. The method as claimed in claim 1, wherein said nozzle arrangement is in the form of a spray-through cap.

8. The method as claimed in claim 1, wherein said nozzle arrangement comprises two releasably connectable parts, each of the two connectable parts having an abutment surface which, when the two abutment surfaces of the two connectable parts are brought into contact, define therebetween a fluid outlet, a fluid inlet and a fluid flow passage which connects the fluid outlet to the fluid inlet.

9. The method as claimed in claim 1, wherein at least 95% of said bubbles or pockets of gas have a maximum size dimension of 0.5 millimeters or less.

10. The method as claimed in claim 1, wherein 98% to 99% of said bubbles or pockets of gas have a maximum size dimension of 0.5 millimeters or less.

11. The method as claimed in claim 1, wherein 98% to 99% of said bubbles or pockets of gas have a maximum size dimension of 0.15 millimeters or less.

12. The method as claimed in claim 1, wherein 98% to 99% of said bubbles or pockets of gas have a maximum size dimension of 0.07 millimeters or less.
